(19) United States
(12) Patent Application Publication
(10) Pub. No.: US 2006/0104705 A1
(43) Pub. Date: May 18, 2006

(54) Grout sealant liquid applicator

(76) Inventor: Roger S. Bruttomesso, Naples, FL (US)

Correspondence Address: Roger Bruttomesso, 683 104th Ave. North, Naples, FL, 34108, US

(21) Appl. No.: 10/988,887

(22) Filed: Nov. 15, 2004

(51) Int. Cl. A46B 11/00; B05C 21/00

(52) U.S. Cl. 401/193; 401/48; 401/220

(57) ABSTRACT

An applicator assembly for a liquid grout sealer including a wheel-type applicator liquid grout sealer applicator and a handle assembly that includes an activation mechanism, a grip, an extension shaft, and a holster adapted to grip the liquid grout sealer applicator.

### FIELD OF THE INVENTION

This invention relates to wheel types of applicators for grout-sealant liquids and attachments thereto.

### BACKGROUND OF THE INVENTION

Tile-laying artisans and do-it-yourselfers conventionally have used various types of paint strippers to apply liquid sealant to grout-containing spaces between and at edges of tiling. Thin and highly viscose grout sealant requires a different type of applicator than for lower-viscose and thicker characteristics of paint.

Examples of different but related wheel-types of stripping applicators are described in the following patent documents. U.S. Pat. No. 4,212,556, issued to Kohler, described a wheel type of paint stripper that was limited to slots like spur gears or other paint-container cavities on circumferential peripheries of circumferentially sectioned stripper wheels that allowed escape and drying of more viscose grout sealant before it could be applied effectively to grout spaces.

U.S. Pat. No. 5,302,043, issued to Velliquette, described a wheel type of grout-sealant applicator having a porously absorbent wheel positioned between washer-like non-porous disks with slightly smaller diameters to prevent escape of viscose grout sealant. Problems in applying grout with known applicators continue to exist, however.

U.S. Pat. No. 5,934,816, issued to the present inventor, Bruttomesso, describes a wheel-type grout sealant liquid applicator and is incorporated herein by reference. More specifically, this patent discloses liquid grout sealant applicator assembly comprising a fluid-conveyance cap having a container end and an applicator end; a wheel-attachment bracket on the applicator end of the fluid-conveyance cap; at least one applicator wheel positioned concentrically on at least one applicator axle; axle bays as wheel-attachment means with which the applicator axle is snap-attached detachably to the wheel-attachment bracket; a liquid-conveyance surface on an outside circumferential periphery of the applicator wheel; an applicator nozzle in the applicator end of the fluid-conveyance cap at a select position near the liquid-conveyance surface on the outside circumferential periphery of the applicator wheel; a plurality of applicator wheels having respective application axles and having select widths, diameters and liquid-conveyance surfaces on outside circumferential peripheries thereof, each of which can be attached to the wheel-attachment means by detachable attachment of the applicator axle to the wheel-attachment bracket. This invention may not prevent leaking at the valve under some conditions and does not provide for an attachment to allow for the application of grout sealant while standing. The present invention has an improved valve designed to reduce leakage and provides an attachment to allow application of the grout sealant while standing.

U.S. Pat. No. 6,386,782, issued to White, describes a grout sealant liquid applicator with an elongated tubular body defining a sealer reservoir, a sealer valve at an end of the tubular body including a spring normally biasing the sealer valve into the closed position and pressure activated by axial pressure on the tubular body into an open position against the bias of the spring, and an applicator wheel carried by the sealer valve for receiving sealer from the reservoir through the sealer valve in the open position and for distributing sealer. However, this invention does not disclose an attachment to a wheel-type liquid grout sealant to allow for the application of grout sealant while standing.

None of the prior art discloses an attachment to a wheel-type grout sealant applicator that allows one to apply grout to the floor while standing. Additionally, none of the prior art wheel-type group sealant applicators provide for the improved valve disclosed herein.

### SUMMARY OF THE PREFERRED EMBODIMENTS

An aspect of the present invention provides for an improved valve in a wheel-type grout sealant liquid applicator to minimize leakage.

Another aspect of the present invention provides for an attachment to a wheel-type grout sealant liquid applicator to allow use while standing.

Another aspect of the present invention provides for a method of using an attachment to a wheel-type grout sealant liquid applicator while standing.

### BRIEF DESCRIPTION OF THE DRAWINGS

The following discussion may be best understood with reference to the various views of the drawings, described in summary below, which form a part of this disclosure.

FIG. 1 is a side view of an embodiment of an applicator assembly of the present invention.

FIG. 2 is a side view of the proximal portion of the applicator assembly depicted in FIG. 1.

FIG. 3 is a side view of the distal portion of the applicator assembly depicted in FIG. 1.

FIG. 4 is a cross-sectional view of an embodiment of an improved valve of the present invention.

FIG. 5 is a cross-sectional view of an embodiment of an improved valve of the present invention.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein. Rather, these embodiments are provided as illustrations so that this disclosure will be thorough and complete, and will fully convey the scope of the invention to those skilled in the art. Like numbers refer to like elements throughout all drawings.

It will be understood that when an element is referred to as being “connected to” another element, it can be directly connected to the other element or intervening elements may also be present. In contrast, when an element is referred to as being “directly connected to” another element, there are no intervening elements present. When an element is referred to as being “adjacent” another element, it can be near the other element but not necessarily independent of the other element. When an element is referred to as being “between” two things, it can be either partly or completely between those two things, but is not necessarily completely and continuously between those two things. The term “adapted to” should be construed to mean “capable of”. The term “device” can refer to an object, apparatus, and/or machine.

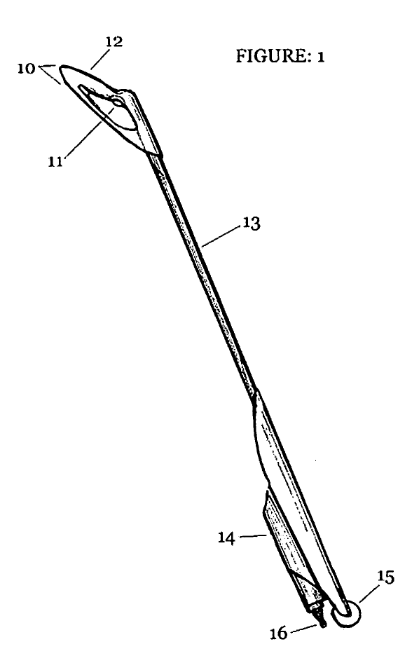

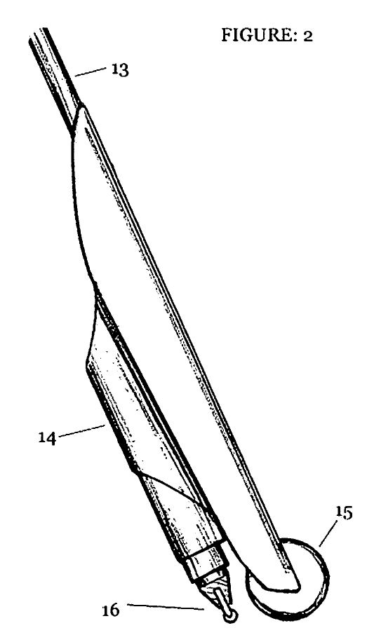

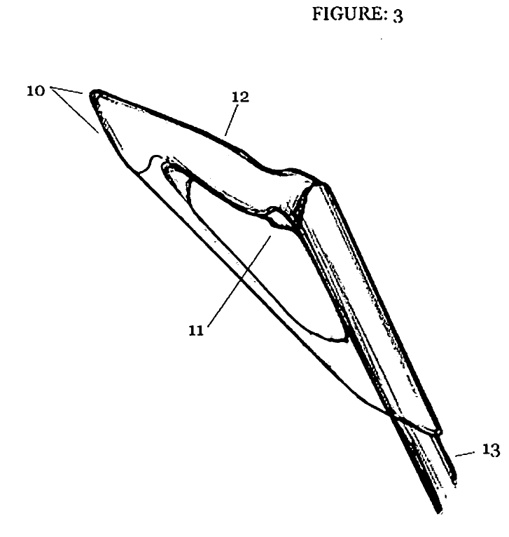

In reference to the embodiment shown in FIGS. 1-3, an applicator assembly includes a handle assembly 10 with a proximal end and a distal end and a liquid grout sealer applicator 16. The handle assembly 10 includes an activation mechanism 11 and a grip 12 on the distal end, a extension shaft 13, and a holster 14 and a roller guide 15 on the proximal end. The holster 14 is adapted to secure a liquid grout sealer application, which is a wheel-type grout sealant applicator 16.

The activation mechanism 11 is adapted to dispense the grout sealant from the wheel-type grout sealant applicator 16.

In a preferred embodiment, the handle assembly 10 is approximately 33 inches from the distal end to the proximal end to allow an adult to apply grout sealant to a surface while standing, kneeling, or other positions. The extension shaft 13 connects the proximal end at the handle assembly to the distal end of the handle assembly. The extension shaft 13 may be expandable or retractable in length to adjust for various individual user heights and/or working conditions.

The holster 14 houses the wheel-type grout sealant applicator and contains a mechanism that squeezes the applicator bottle to dispense the sealer when the trigger mechanism is depressed.

Roller guide assembly 15 tracks along the floor to guide the application of the sealer from a valve 40 of the wheel-type grout sealant applicator 16.

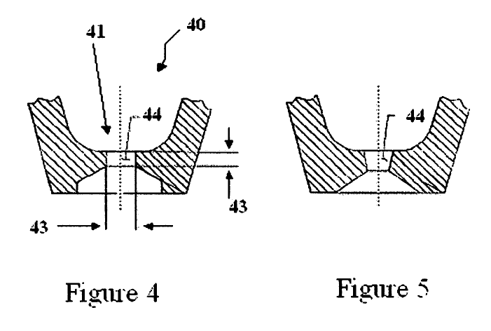

In reference to FIGS. 4 and 5, the valve 40 includes an orifice 41. The volume of liquid grout sealant dispersed is in part controlled per unit of time by pressure on the activation mechanism 11 and also controlled per unit of time by a valve length 42, a orifice diameter 43, and a orifice angle 44.

It has been discovered that when the valve length 42 is no shorter than 0.010 inches, leakage is reduced. In a preferred embodiment, the valve length 42 will be substantially between 0.010 and 0.060 inches, and in a more preferred embodiment, the valve length 42 will be substantially 0.030 inches.

It has been further discovered that when the orifice diameter 43 is no shorter than 0.020 inches, leakage is reduced. In a preferred embodiment, the orifice diameter 43 will be substantially between 0.020 to 0.070 inches, and in a more preferred embodiment, the orifice diameter 43 will be substantially 0.030 inches.

Additionally, when the orifice angle 44 is no less than 5 degrees, leakage is reduced. While not limiting the invention to one scientific theory, it is believed that the orifice angle 44 increases the venturi effect on the grout sealant which results in an increase in the fluid exit pressure. This decreases leakage in the improved valve of the present invention. In a preferred embodiment, the orifice angle 44 will be substantially between 5 degrees and 45 degrees, and in a more preferred embodiment, the orifice angle 44 will be substantially 30 degrees.

What is claimed:

1. An applicator assembly for a liquid grout sealer comprising:
a liquid grout sealer applicator; and,
a handle assembly;
wherein the handle assemble comprised a proximal end and a distal end;
wherein the liquid grout sealer applicator is a wheel-type applicator;
wherein the handle assembly further comprises an activation mechanism and a grip on the distal end
wherein the handle assembly further comprises an extension shaft, and
wherein the handle assembly further comprises a holster on the proximal end adapted to grip the liquid grout sealer applicator.

2. The applicator assembly of claim 1, wherein the handle assembly further comprises a guide.

3. The applicator assembly of claim 2, wherein the guide is a roller-type guide.

4. The applicator assembly of claim 1, wherein the extension shaft is adjustable in length.

5. The applicator assembly of claim 1, wherein the handle assembly is substantially 33 inches in length.

6. The applicator assembly of claim 5, wherein the handle assembly further comprises a guide.

7. The applicator assembly of claim 6, wherein the guide is a roller-type guide.

8. A method for applying a liquid grout sealer comprising:
attaching a liquid grout sealer applicator to a handle assembly;
wherein the liquid grout sealer applicator is a wheel-type applicator;
wherein the a handle assembly further comprises a proximal end and a distal end;
wherein the a handle assembly further comprises an activation mechanism and a grip on the distal end,
wherein the a handle assembly further comprises an extension shaft,
wherein the a handle assembly further comprises a holster on the proximal end, and
wherein the holster is adapted to grip the liquid grout sealer applicator;
activating the activation mechanism in the handle assembly to apply the liquid grout sealer.

9. The method of claim 8, wherein the handle assembly further comprises a roller-type guide.

10. The method of claim 8, wherein the extension shaft is adjustable in length.

11. The method of claim 9, wherein the handle assembly further comprises a guide.

12. The method of claim 8, wherein the handle assembly is substantially 33 inches in length.

13. An improved liquid grout sealant applicator assembly comprising a fluid-conveyance cap having a container end and an applicator end; a wheel-attachment bracket on the applicator end of the fluid-conveyance cap; at least one applicator wheel positioned concentrically on at least one applicator axle; axle bays as wheel-attachment means with which the applicator axle is snap-attached detachably to the wheel-attachment bracket; a liquid-conveyance surface on an outside circumferential periphery of the applicator wheel; an applicator nozzle in the applicator end of the fluid-conveyance cap at a select position near the liquid-conveyance surface on the outside circumferential periphery of the applicator wheel; a plurality of applicator wheels having respective application axles and having select widths, diameters and liquid-conveyance surfaces on outside circumferential peripheries thereof, each of which can be attached to the wheel-attachment means by detachable attachment of the applicator axle to the wheel-attachment bracket, the improvement comprising:
a valve orifice with an valve length substantially between 0.20 and 0.70 inches, an orifice diameter substantially between 0.010 and 0.060 inches, and an orifice angle substantially between zero and 45 degrees.

14. The improved applicator assembly of claim 13, wherein the valve length is substantially 0.030 inches.

15. The improved applicator assembly of claim 13, wherein the orifice diameter is substantially 0.030 inches.

16. The improved applicator assembly of claim 13, wherein the orifice angle is substantially between 5 degrees and 45 degrees.

17. The improved applicator assembly of claim 13, wherein the orifice angle is substantially 30 degrees.

18. The improved applicator assembly of claim 13, wherein the valve length is substantially 0.030 inches, the orifice diameters is substantially 0.030 inches, and the orifice angle is substantially 30 degrees.

19. The improved applicator assembly of claim 13, wherein the assembly further comprises a handle assembly, wherein the handle assembly further comprises an activation mechanism, a grip, an extension shaft, and a holster adapted to grip the liquid grout sealer applicator.

20. The improved applicator assembly of claim 19, wherein the valve length is substantially 0.030 inches, the orifice diameters is substantially 0.030 inches, and the orifice angle is substantially 30 degrees.
